(19) United States
(12) Patent Application Publication
(10) Pub. No.: US 2006/0152877 A1
(43) Pub. Date: Jul. 13, 2006

(54) Transient suppression circuit

(76) Inventors: Brian W. Buzzard, Lancaster, NY (US); Daniel R. Wiegand, Lockport, NY (US)

Correspondence Address: DYKEMA GOSSETT PLLC, Suite 300, 39577 Woodward Avenue, Bloomfield Hills, MI, 48304, US

(21) Appl. No.: 11/033,648

(22) Filed: Jan. 12, 2005

(51) Int. Cl. H02H 9/06

(52) U.S. Cl. 361/118

(57) ABSTRACT

A transient suppression circuit is provided. The circuit comprises a first node having positive and negative terminals and being configured to be electrically coupled to a switching control circuit. The switching control circuit is operative to provide power to an inductive load. The circuit includes a second node having positive and negative terminals and being configured to be electrically coupled to the inductive load. A first conductor is connected between the positive terminals of the first and second nodes and is configured to provide a current path between the switching control circuit and inductive load. The circuit further includes a second conductor connected between the negative terminals of the first and second nodes and is configured to provide a return current path between the inductive load and the switching circuit. One of the first and second conductors further includes a switching device selectively coupling the inductive load and switching circuit.

### BACKGROUND OF THE INVENTION

1. Technical Field

This invention relates generally to transient suppression circuits. More particularly, this invention relates to a transient suppression circuit for enhancing the response of an inductive device while at the same time providing protection to the switching control circuit that controls the operation of the inductive device.

2. Discussion of the Related Art

Inductive devices are often times specified for various applications either as required elements or as add-on or optional accessories. One such field in which inductive devices are prevalent is industrial control. For example, in industrial plants a servo motor may be used to control the vertical axis of a given machine. When power is cut-off as a result of an unexpected power outage, for example, an inductive device such as a “power-off” brake is used to prevent the load on the machine from falling to the floor. Another field in which inductive devices are used is in automobiles having four wheel drive capabilities. In this application a power-on or power-off brake maybe used to control the shifting between two wheel drive and four wheel drive. When the system receives the command to switch from two wheel to four wheel, the brake releases to allow for the shift to occur. Once the shift is complete, the brake re-engages. Yet another application is golf-cart safety brakes.

In addition to those inductive devices described above, other inductive devices include electromagnetic clutches and solenoids. When needed, the response time of the inductive device can be critical to the performance of the overall system. For example, when engaging a “power-off” brake, the response time of applying the brake once power is removed is critical, as is illustrated in the industrial plant example described above. However, during transient operation of the inductive devices, such as switching off an electromagnetic clutch or brake, a high reverse voltage spike, or “fly-back voltage”, may be generated. This voltage spike can be damaging to the components that make up the switching control circuit, such as, for example, mechanical switches or solid state switching control, used to control the operation of the inductive device. Accordingly, protection against these damaging transient voltages is desired and often times required or specified in order to eliminate or minimize the risk of damage posed by these transient voltage spikes to the switching device or control circuitry.

In some conventional systems, protection circuits are included within the switching or control circuits to prevent these transient voltages from damaging the switching or control circuitry. There are, however, disadvantages to these conventional arrangements. For instance, the integrated protection circuits often cause a conflict between protection requirements of the control circuitry and performance requirements of the inductive devices, such as switching response time, and accordingly, can adversely alter the performance of the overall system. Therefore, while the protection circuits protect the switching devices by suppressing the damaging transient voltages, the critical response time of the switching device is often times detrimentally altered.

Accordingly, a need exists for a circuit for enhancing the performance of an inductive device that minimizes and/or eliminates one or more of the above identified deficiencies.

### SUMMARY OF INVENTION

A circuit for enhancing the response time of an inductive load is presented. A circuit in accordance with the present invention includes a first node having positive and negative terminals and being configured to be electrically coupled to a switching control circuit wherein the switching control circuit is operative to selectively provide power from a power source to an inductive load. The circuit further includes a second node having positive and negative terminals and being configured to be electrically coupled to the inductive load, and a first conductor electrically connected between the positive terminals of the first and second nodes. The first conductor is configured to provide a current path between the switching control circuit and the inductive load. The inventive circuit still further includes a second conductor electrically connected between the negative terminals of the first and second nodes. The second conductor is configured to provide a return current path between the inductive load and the switching circuit.

One of the first and second conductors further includes a switching device configured to selectively couple the inductive load to the switching control circuit. The switching device has first and second switching states wherein the inductive load and the switching circuit are electrically connected in the first state and disconnected in the second state.

### DESCRIPTION OF DRAWINGS

FIG. 1 is a schematic block diagram of a system incorporating the inventive protection circuit;

FIG. 2 is a schematic block diagram of the inventive circuit;

FIG. 3 is a schematic diagram of an exemplary embodiment of the inventive circuit;

FIG. 4 is a schematic diagram of an alternate exemplary embodiment of the inventive circuit; and

FIG. 5 is a chart showing test results of a particular application utilizing the inventive circuit.

### DETAILED DESCRIPTION OF THE INVENTION

Referring now to the drawings wherein like reference numerals are used to identify identical components in the various views, FIG. 1 shows a block diagram of a system 10 incorporating the inventive transient suppression circuit. In an exemplary embodiment, system 10 includes a power supply 12, a switching control circuit 14, the inventive transient suppression circuit 16 and an inductive device or load 18. Switching control circuit 14 is operative to selectively couple power supply 12 and inductive device 18 together, while transient suppression circuit 16 is provided to protect switching control circuit 14 from harmful reverse voltage spikes generated by inductive device 18. In the illustrated embodiment, switching control circuit 14 is electrically coupled to transient suppression circuit 16 at a first node 20, and transient suppression circuit 16 is electrically coupled to inductive device 18 at a second node 22. As will be discussed below, first and second nodes 20, 22 each include a respective positive and negative terminal to facilitate the electrical connection of switching control circuit 14 and inductive device 18.

Switching control circuit 14 may take various forms such as a mechanical switch, a solid state control circuit, or any other known control devices. It may also have its own power supply or be a power supply itself thereby negating the necessity of having a separate and distinct power supply 12. Often times switching control circuit 14 will include an integrated suppression circuit or control 24 that serves to protect the mechanical switch or control circuit comprising switching control circuit 14, for example, from harmful reverse voltage spikes (fly-back voltage) that may be generated by the inductive load (i.e., inductive device 18) to which it is connected. However, as discussed in the “Background of the Invention” section above, these integrated suppression circuits may have adverse effects on the crucial response time of inductive device 18, and therefore, the overall performance of system 10. As will be discussed in greater detail below, it is these adverse effects that transient suppression circuit 16 is provided to protect against.

Inductive device 18 may also take various known forms. For example, as described in greater detail above, inductive device 18 may be an electromagnetic power-on or power-off brake, an electromagnetic clutch, or a solenoid. It should be noted, however, that these types of inductive devices are provided for exemplary and environmental purposes only and are not meant to be limiting in nature. One inherent drawback of inductive devices is the generation of reverse voltage spikes that can be harmful to the components and/or circuitry of switching control circuit 14 that control the supply of power to, and operation of, inductive device 18. As will be discussed next, transient suppression circuit 16 serves to protect switching control circuit 14 from these damaging voltage spikes.

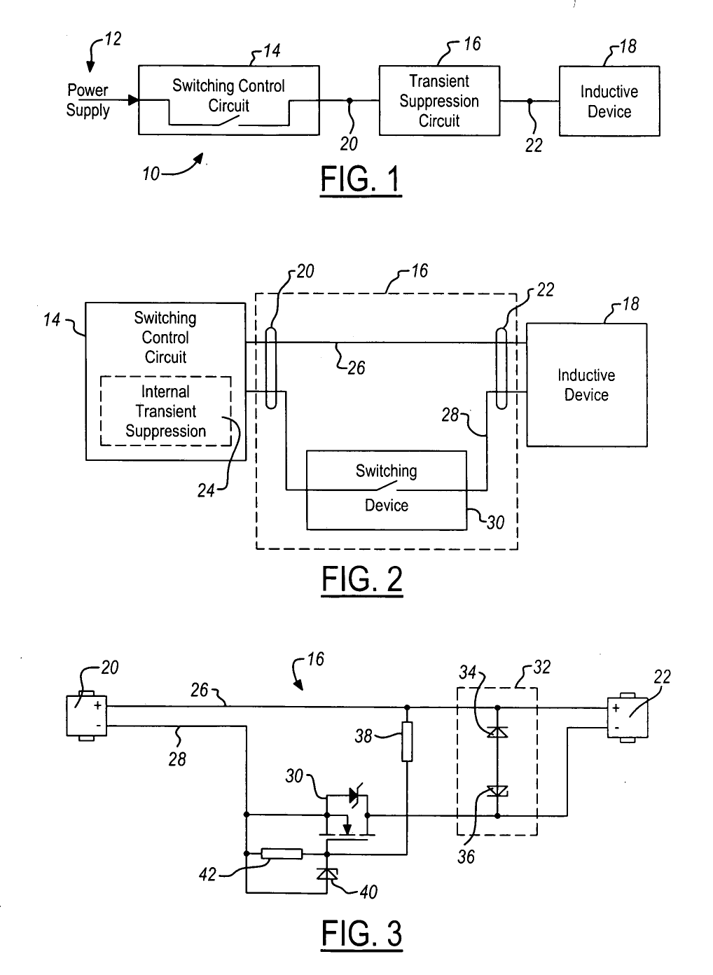

With reference to FIGS. 2-4, an exemplary embodiment of transient suppression circuit 16 is illustrated. Transient suppression circuit 16 is configured to be connected between switching control device 14 and inductive device 18, and is, therefore, a separate and distinct component from both switching control circuit 14 and inductive device 18. In the illustrated embodiment shown in FIG. 3, and in its simplest form, transient suppression circuit 16 includes first node 20, second node 22, a first conductor 26, a second conductor 28 and a switching device 30. First conductor 26 is arranged and configured to electrically connect the positive terminal of first node 20 to the positive terminal of second node 22 so as to provide a current path between switching control circuit 14 and inductive device 18. Second conductor 28 is arranged and configured to electrically connect the negative terminal of second node 20 to the negative terminal of first node 22 so as to provide a return current path between inductive device 18 and switching control circuit 14.

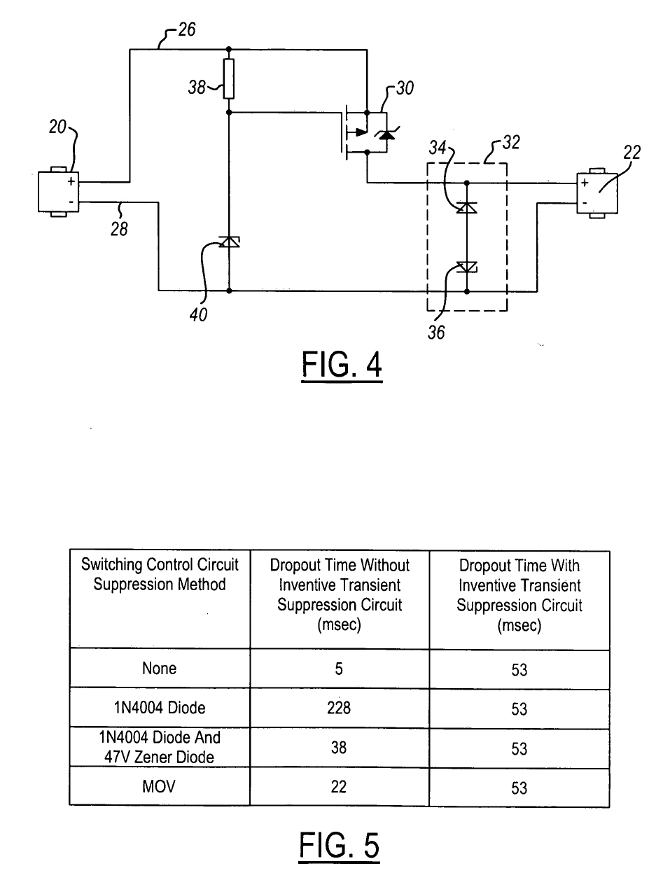

In the exemplary embodiment depicted in FIG. 3, second conductor 28 includes switching device 30 connected therein, and switching device 30 is configured to selectively couple inductive load 18 and switching control circuit 14 together. However, as will be discussed in greater detail below, in an alternate embodiment, first conductor 26 rather than second conductor 28 includes switching device 30 (best shown in FIG. 4). In either embodiment, switching device 30 has first and second switching states, and in an exemplary embodiment, provides an electrical connection between inductive device 18 and switching control circuit 14 when in the first switching state, and disconnects inductive device 18 and switching control circuit 14 when in the second switching state. In an exemplary embodiment, switching device 30 is configured to take on the first state when power is applied to first node 20. Conversely, switching device 30 is configured to take on the second switching state when power is removed from first node 20.

With reference to the embodiment depicted in FIG. 3 wherein switching device 30 is included in second conductor 28, switching device 30 is a n-channel field effect transistor (FET). For purposes of simplicity and clarity, switching device 30 will hereinafter be referred to as FET 30 and transient suppression circuit 16 will be described with respect to switching device 30 being FET 30. However, switching device 30 should not be construed to be so limited. Rather, those skilled in the art will recognize that numerous electrically actuated switching devices exist that have the same functionality as a FET, and therefore, could be used in place of FET 30. In the illustrated embodiment, the gate terminal of FET 30 is connected to first conductor 26 (and therefore, the positive terminal of first node 20), the source terminal is connected to the negative terminal of first node 20 and the drain terminal is connected to the negative terminal of second node 22. In this configuration, FET 30 taps off the power line to provide the input/conduction voltage to the gate terminal. Accordingly, when power is being supplied to inductive device 18 by way of switching control circuit 14, power is also being applied to FET 30 so as to cause FET 30 to conduct, thereby completing the circuit between inductive device 18 and switching control circuit 14.

With continued reference to FIG. 3, in an exemplary embodiment, transient suppression circuit 16 further includes a protective suppression block 32 that provides protection for FET 30 against reverse voltage spikes generated by inductive device 18. In the illustrated embodiment, suppression block 32 is electrically connected across first conductor 26 and second conductor 28. In an exemplary embodiment, suppression block 32 comprises the series combination of a diode 34 (e.g., an 1N4004 diode) and a zener diode 36 (e.g., a 50V zener diode). In this arrangement, the cathode of diode 34 is connected to first conductor 26 and the anode is connected to the anode of zener diode 36. The cathode of zener diode 36 is connected to second conductor 28. It should be noted, however, that other forms of suppression, both passive and active, exist that remain within the spirit and scope of this invention. For example, in an alternate embodiment, suppression block 32 comprises a metal oxide varistor (MOV). In another embodiment, suppression block 32 comprises a single silicon diode. In yet another alternate embodiment, FET 30 is of the type that includes internal active suppression, and thus, suppression block 32 is not external to or separate from FET 30, but rather is internal to FET 30. In yet still another alternate embodiment, FET 30 has a sufficiently high VDS (Drain to Source Voltage) such that suppression is not needed.

In an exemplary embodiment, transient suppression circuit 16 further includes a current limiting resistor 38 and a voltage regulating zener diode 40. As shown in FIG. 3, resistor 38 is electrically connected between the gate terminal of FET 30 and first conductor 26 and limits the current supplied to the gate terminal, while zener diode 40 is electrically connected between the gate terminal of FET 30 and the negative terminal of first node 20 and operates to regulate the voltage supplied to the gate. The combination of resistor 38, which in an exemplary embodiment is a five kilo-ohm resistor, and zener diode 40 is operative to regulate or hold the voltage applied to the gate terminal to the predetermined switching voltage required to cause FET 30 to conduct. Zener diode 40 is an important element as it provides a measure of flexibility for FET 30 with respect to the input voltage levels provided. For example, in an exemplary embodiment zener diode 40 is a 5.1 volt device. This device allows FET 30, or another equivalent device, to be used in applications where the input voltage ranges from as little as six volts to as high as 90 volts, for example. It should be noted however, in alternate embodiments, the values of the various components of the inventive circuit may be changed so as to allow for the circuit to be used in virtually any application having virtually limitless input voltages. Accordingly, zener diode 40 regulates the input voltage such that FET 30 will operate throughout a wide range of input voltages.

With continued reference to FIG. 3, in an exemplary embodiment transient suppression circuit 16 further includes a resistor 42 electrically connected between the gate terminal of FET 30 and the negative terminal of first node 20. Resistor 42 is configured to pull the voltage at the gate terminal of FET 30 to zero volts when power is removed from the positive terminal of first node 20 such that FET 30 will open, thereby disconnecting inductive device 18 from switching control circuit 14. In one embodiment, resistor 42 is a 100 kilo-ohm resistor.

With reference to FIG. 4, and as noted above, in an alternate embodiment, FET 30 is included in first conductor 26. In this embodiment, FET 30 is a p-channel FET wherein the gate terminal of FET 30 is connected to both current limiting resistor 38, which is connected to the positive terminal of first node 20, and the cathode of zener diode 40, the anode of which is connected to second conductor 28. In this embodiment, the source terminal of FET 30 is connected to the positive terminal of first node 20 and the drain terminal is connected to the positive terminal second node 22. In this configuration, FET 30 taps off the power provided at first node 20 to provide the input/conduction voltage to the gate terminal. Accordingly, when power is supplied to inductive device 18, power is also provided to FET 30 so as to cause PET 30 to conduct, thereby completing the circuit between inductive device 18 and switching control circuit 14. The discussion above regarding suppression block 32 applies with equal force to the embodiment depicted in FIG. 4, and therefore, will not be repeated here.

It should be noted that the value of the various components set forth above are provided for exemplary purposes only and are not meant to be limiting in nature. In actuality, some or all of the various components can have different values than those set forth above so as to tune or tailor transient suppression circuit 16 to meet the specifications of any given system having an inductive load where “fly-back” voltage could damage the switching control circuit.

In operation, an exemplary embodiment of the inventive transient suppression circuit shown in FIG. 3 works as follows. When power is applied to the positive terminal of first node (and, therefore, to the inductive device), the switching device (FET) taps off the power supply line (i.e., the first conductor) and conducts, thereby completing the circuit between the inductive device and the switching control circuit. When the voltage applied to the first node is removed, the circuitry of the inventive transient suppression circuit quickly pulls the voltage at the gate of the FET to zero causing the FET to cease conduction, thereby opening the circuit and disconnecting the inductive device from the switching control circuit. As noted above, the response time of the transient suppression circuit is such that damaging reverse voltage spikes are prevented from reaching the switching control circuit. The response time of the FET can be adjusted by varying the values of the components of the transient suppression circuit. A key feature of the present invention is that the inventive circuit operates independently of any transient suppression methods that may be included with the switching control circuit so as to prevent any adverse effects the included suppression methods have on the responsiveness of the overall system, such as, for example, the amount of time that passes between the removal of power and the actuation of a power-off brake.

In the testing of one exemplary system having a particular power-off brake (see FIG. 5 for test results), the dropout time, or time between the removal of power to the movement of the brake armature, ranged from five milliseconds to 228 milliseconds, depending on the transient suppression provided for in the switching control circuit, when the inventive circuit was not used. When the same exemplary system was tested using the inventive circuit, the dropout time was a constant 53 milliseconds regardless of the transient suppression method provided for in the switching control circuit. Accordingly, the inventive circuit eliminates the adverse effects of internal suppression circuits in the switching control circuits, giving the end user a constant “disconnecting” response time, thus improving or enhancing the response time of the inductive device. Consequently, because the inventive transient suppression circuit operates independently of the internal suppression methods of the switching control circuit, the inventive circuit can be used in a multitude of applications and the end user will know the expected response time of the overall system regardless of the internal suppression method.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed:

1. A transient suppression circuit for enhancing the response time of an inductive load, comprising:
a first node having positive and negative terminals, said first node being configured to be electrically coupled to a switching control circuit wherein said switching control circuit is operative to selectively provide power from a power source to an inductive load;
a second node having positive and negative terminals, said second node being configured to be electrically coupled to said inductive load;
a first conductor electrically connected between said positive terminals of said first and second nodes configured to provide a current path between said switching control circuit and said inductive load; and
a second conductor electrically connected between said negative terminals of said first and second nodes configured to provide a return current path between said inductive load and said switching control circuit;
wherein one of said first and second conductors includes a switching device configured to selectively couple said inductive load to said switching control circuit, said switching device having first and second switching states wherein said inductive load and said switching circuit are electrically connected in said first state and disconnected in said second state.

2. A circuit in accordance with claim 1 wherein said switching device includes a protective suppression block configured to protect said switching device from transient voltages generated by said inductive load.

3. A circuit in accordance with claim 2 wherein said protective suppression block is connected across said first and second conductors.

4. A circuit in accordance with claim 3 wherein said protective suppression block includes a series combination of a diode and a zener diode wherein said cathode of said diode is connected to said first conductor, said anode of said diode is connected to the anode of said zener diode, and said cathode of said zener diode is connected to said second conductor.

5. A circuit in accordance with claim 3 wherein said protective suppression block includes a silicon diode.

6. A circuit in accordance with claim 2 wherein said suppression block is internal to said switching device.

7. A circuit in accordance with claim 1 wherein said switching device is operative to take on said first switching state when power is applied at said positive terminal of said first node and to take on said second switching state when power is removed from said first node.

8. A circuit in accordance with claim 7 wherein said switching device is a field effect transistor (FET).

9. A circuit in accordance with claim 8 wherein the gate terminal of said FET is connected to said first conductor so as to provide a switching voltage to said FET, the source terminal is connected to said negative terminal of said first node, and the drain terminal is connected to said negative terminal of said second node.

10. A circuit in accordance with claim 9 further comprising:
a current limiting resistor connected between the gate terminal and said first conductor; and
a zener diode connected between the gate terminal and said negative terminal of said first node; wherein
said resistor and said zener diode arrangement is operative to hold the voltage applied to the gate terminal at a predetermined switching voltage.

11. A circuit in accordance with claim 9 further comprising a resistor connected between said gate terminal of said FET and said negative terminal of said first node wherein said resistor is configured to pull the voltage at the gate terminal to zero (0) volts when power is removed from said positive terminal of said first node.

12. A circuit in accordance with claim 8 wherein the gate terminal of said FET is connected to said positive terminal of said first node so as to provide switching voltage to said FET, the source terminal is connected to said positive node of said first node, and the drain terminal is connected to the positive terminal of said second node.

13. A circuit in accordance with claim 12 further comprising a current limiting resistor connected between said positive terminal of said first node and said gate terminal of said FET; and
a zener diode connected between said gate terminal and said second conductor; wherein
said resistor and said zener diode arrangement is operative to hold the voltage applied to said gate terminal at a predetermined switching voltage.

14. A transient suppression circuit for enhancing the response time of an inductive load, comprising:
a first node having positive and negative terminals, said first node being configured to be electrically coupled to a switching control circuit wherein said switching control circuit is operative to selectively provide power from a power source to an inductive load;
a second node having positive and negative terminals, said second node being configured to be electrically coupled to said inductive load;
a first conductor connected between said positive terminals of said first and second nodes configured to provide a current path between said switching control circuit and said inductive load;
a second conductor connected between said negative terminals of said first and second nodes configured to provide a return current path between said inductive load and said switching control circuit, wherein said second conductor includes a switching device configured to selectively couple said inductive load and said switching control circuit together, said switching device having first and second switching states wherein said inductive load and said switching circuit are electrically connected together in said first switching state and disconnected in said second switching state; and
a protective suppression circuit configured to protect said switching device from transient voltages generated by said inductive load.

15. A circuit in accordance with claim 14 wherein said switching device is a field effect transistor (FET) wherein the gate terminal of said FET is connected to said first conductor so as to provide a switching voltage to said FET, the source terminal is connected to said negative terminal of said first node, and the drain terminal is connected to said negative terminal of said second node.

16. A circuit in accordance with claim 15 further comprising:
a current limiting resistor connected between the gate terminal of said FET and said first conductor; and
a zener diode connected between the gate terminal and said negative terminal of said first node; wherein
said resistor and said zener diode arrangement is operative to hold the voltage applied to the gate terminal at a predetermined switching voltage.

17. A circuit in accordance with claim 15 further comprising a resistor connected between the gate terminal of said FET and said first node wherein said resistor is configured to pull the voltage at the gate terminal to zero (0) volts when power is removed from said first node.

18. A transient suppression circuit for enhancing the response time of an inductive load, comprising:
a first node having positive and negative terminals, said first node being configured to be electrically coupled to a switching control circuit wherein said switching control circuit is operative to selectively provide power from a power source to an inductive load;
a second node having positive and negative terminals, said second node being configured to be electrically coupled to said inductive load;
a first conductor connected between said positive terminals of said first and second nodes configured to provide a current path between said switching control circuit and said inductive load;
a second conductor connected between said negative terminals of said first and second nodes configured to provide a return current path between said inductive load and said switching control circuit; wherein
said first conductor includes a switching device configured to selectively couple said switching control circuit and said inductive load together, said switching device having first and second switching states wherein said inductive load and said switching control circuit are electrically connected together in said first switching state and disconnected in said second switching state; and
a protective suppression circuit configured to protect said switching device from transient voltages generated by said inductive load.

19. A circuit in accordance with claim 18 wherein said switching device is a field effect transistor (FET) wherein the gate terminal of said FET is connected to said positive terminal of said first conductor so as to provide a switching voltage to said FET, the source terminal is connected to said positive terminal of said first node, and the drain terminal is connected to said positive terminal of said second node.

20. A circuit in accordance with claim 19 further comprising:
a current limiting resistor connected between the gate terminal of said FET and said positive terminal of said first node; and
a zener diode connected between the gate terminal and said second conductor; wherein
said resistor and said zener diode arrangement is operative to hold the voltage applied to the gate terminal at a predetermined switching voltage.
